(19) United States
(12) Patent Application Publication
(10) Pub. No.: US 2026/0222933 A1
(43) Pub. Date: Jul. 30, 2026

(54) CAPABILITY INFORMATION REPORTING METHOD AND APPARATUS

(71) Applicant: BEIJING XIAOMI MOBILE SOFTWARE CO., LTD., Beijing (CN)

(72) Inventor: Shengxiang GUO, Beijing (CN)

(73) Assignee: BEIJING XIAOMI MOBILE SOFTWARE CO., LTD., Beijing (CN)

(21) Appl. No.: 19/145,646

(22) PCT Filed: Jan. 6, 2023
(86) PCT No.: PCT/CN2023/071028

§ 371 Date: Jul. 3, 2025

(51) Int. Cl. H04W 36/00; H04W 36/06

(52) U.S. Cl. CPC H04W 36/008357; H04W 36/06

(57) ABSTRACT

A method for reporting capability information is provided, the method is performed by a terminal, and comprises: reporting transmission capability information to a network device, wherein the transmission capability information indicates a capability of transmitting data using a first link when uplink switching of multiple bands occurs on at least one link, wherein the at least one link is other than the first link among a plurality of links.

### CROSS-REFERENCE TO RELATED APPLICATIONS

This application is the U.S. National Stage Application of International Application No. PCT/CN2023/071028, filed on Jan. 6, 2023, the entire disclosure of which is incorporated herein by reference.

### TECHNICAL FIELD

The present disclosure relates to a field of communication technology, and specifically to a method and an apparatus for reporting capability information, a device and a storage medium.

### BACKGROUND

In a communication system, in order to support a higher transmission rate, a multi-carrier technology (such as carrier aggregation (CA)) is widely used. In new radio (NR) of 5th generation mobile communication technology (5G), an uplink switching function is introduced starting from Rel-16. When a terminal performs uplink switching, due to a potential reason, for example, carrier frequencies of two links are close or there is a harmonic wave and other interference or there are some components used commonly, switching of one link will cause interference to the other link.

### SUMMARY

According to a first aspect of the embodiments of the present disclosure, a method for reporting capability information is provided, performed by a terminal, including:
reporting transmission capability information to a network device, in which the transmission capability information indicates a capability of transmitting data using a first link when uplink switching of multiple bands occurs on at least one link, in which the at least one link is other than the first link among a plurality of links.

According to a second aspect of the embodiments of the present disclosure, a method for reporting capability information is provided, performed by a network device, including:
receiving transmission capability information reported by a terminal, in which the transmission capability information indicates a capability of transmitting data using a first link when uplink switching of multiple bands occurs on at least one link, in which the at least one link is other than the first link among a plurality of links.

According to a third aspect of the embodiments of the present disclosure, a terminal is provided, including a processor and a memory for storing a computer program, in which when the computer program stored in the memory is executed by the processor, the terminal is caused to implement the method in the above first aspect.

### BRIEF DESCRIPTION OF THE DRAWINGS

The above and/or other aspects and advantages of embodiments of the present disclosure will become apparent and more readily understandable from the following descriptions made with reference to the accompanying drawings.

FIG. 1 is a schematic diagram of an example of uplink switching according to an embodiment of the present disclosure.

FIG. 2 is a flowchart of a method for reporting capability information according to an embodiment of the present disclosure.

FIG. 3 is a flowchart of a method for reporting capability information according to another embodiment of the present disclosure.

FIG. 4 is a flowchart of a method for reporting capability information according to another embodiment of the present disclosure.

FIG. 5 is a flowchart of a method for reporting capability information according to another embodiment of the present disclosure.

FIG. 6 is a flowchart of a method for reporting capability information according to another embodiment of the present disclosure.

FIG. 7 is a flowchart of a method for reporting capability information according to another embodiment of the present disclosure.

FIG. 8 is a flowchart of a method for reporting capability information according to another embodiment of the present disclosure.

FIG. 9 is a flowchart of a method for reporting capability information according to another embodiment of the present disclosure.

FIG. 10 is a flowchart of a method for reporting capability information according to another embodiment of the present disclosure.

FIG. 11 is a flowchart of a method for reporting capability information according to another embodiment of the present disclosure.

FIG. 12 is a flowchart of an apparatus for reporting capability information according to an embodiment of the present disclosure.

FIG. 13 is a flowchart of an apparatus for reporting capability information according to another embodiment of the present disclosure.

FIG. 14 is a block diagram of a terminal according to an embodiment of the present disclosure.

FIG. 15 is a block diagram of a network device according to an embodiment of the present disclosure.

### DETAILED DESCRIPTION

Descriptions will now be made in detail to illustrative embodiments, examples of which are illustrated in the accompanying drawings. The following description refers to the accompanying drawings in which the same numbers in different drawings represent the same or similar elements unless otherwise represented. The implementations set forth in the following description of illustrative embodiments do not represent all implementations consistent with the present disclosure. Instead, they are merely examples of apparatuses and methods consistent with aspects related to the embodiments of the present disclosure as recited in the appended claims.

The terms used in the embodiments of the present disclosure are solely for the purpose of describing a particular embodiment and are not intended to limit embodiments of the present disclosure. The terms “a/an” and “the” in a singular form used in embodiments and claims of the present disclosure are also intended to include a plural form, unless the context clearly indicates other meaning. It should also be understood that the term “and/or” as used herein refers to any or all possible combinations of one or more associated listed items.

It should be understood that although the terms first, second, third, etc. may be used to describe various information in the embodiments of the present disclosure, such information should not be limited to these terms. These terms are used only to distinguish between information in the same type. For example, without departing from the scope of embodiments of the present disclosure, first information may also be referred to as second information, and similarly, the second information may be referred to as the first information. Depending on the context, words “if” and “in case that” used here may be interpreted as “when”, “while”, or “in response to determining . . . .”

A network element or a network function in the embodiments of the present disclosure may either be implemented by an independent hardware device or by software in a hardware device, which is not limited in the embodiments of the present disclosure.

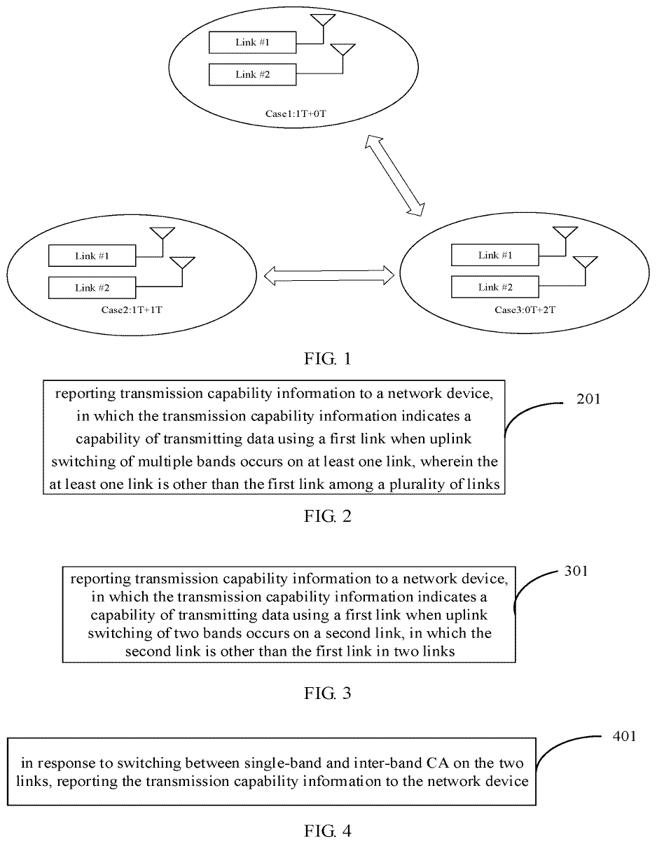

In a communication system, FIG. 1 is a schematic diagram of an example of uplink switching according to an embodiment of the present disclosure. In 5G NR, an uplink switching (i.e., a so-called super uplink) function is introduced starting from Rel-16. An introduction of this function aims to enhance an uplink transmission performance for an uplink band combination, including E-UTRA-NR dual connectivity (EN-DC), carrier aggregation (CA), and supplementary uplink (SUL). This function may achieve a coordination between a high frequency and a low frequency via the uplink switching, that is, when an uplink coverage of a high-frequency carrier is insufficient, a system switches to a low-frequency carrier to improve the uplink coverage. When the uplink coverage is sufficient, the system uses a large bandwidth of the high-frequency carrier and a multiple-in-multiple-out (MIMO) technology to achieve a high-speed transmission. According to relevant standards, only uplink switching between two bands is supported. The terminal will report its own capabilities, which, for example, may include two supported bands for the uplink switching, a switching cycle, and a band where a downlink interruption occurs.

In an embodiment of the present disclosure, when a terminal performs the uplink switching, due to a potential reason, for example, carrier frequencies of two links are close or there is a harmonic wave and other interference or there are some components used commonly, switching of one link will cause interference to the other link. For a terminal with a lower capability, a link that without switching or whose switching process is completed generally does not transmit when switching is performed on the other link. This may effectively reduce the interference between the two links, but also reduce system throughput. For a terminal with a stronger capability, when switching is performed on one link, it is ensured that the other link may transmit normally, thereby improving the system throughput.

With reference to accompanying drawings, a method and an apparatus for reporting capability information, a device and a storage medium in the embodiments of the present disclosure are described in detail.

FIG. 2 is a flowchart of a method for reporting capability information according to an embodiment of the present disclosure. The method is performed by a terminal. As shown in FIG. 2, the method may include S201.

At S201, transmission capability information is reported to a network device, in which the transmission capability information indicates a capability of transmitting data using a first link when uplink switching of multiple bands occurs on at least one link, in which the at least one link is other than the first link among a plurality of links.

It needs to be noted that, in an embodiment of the present disclosure, the terminal may be a device that provides voice and/or data connectivity to a user. The terminal may communicate with one or more core networks via a radio access network (RAN). The terminal may be an Internet of Things (IoT) terminal, such as a sensor device, a mobile phone (also known as “cellular” phone), and a computer with the IoT terminal. For example, the terminal may be a fixed, portable, pocket, handheld, computer built-in or vehicle-mounted device, for example, a station (STA), a subscriber unit, a subscriber station, a mobile station, a mobile, a remote station, an access point, a remote terminal, an access terminal, a user terminal, or a user agent. Or, the terminal may be a device for an unmanned aerial vehicle (UAV). Or, the terminal may also be a vehicle-mounted device, for example, a vehicle computer with a wireless communication function, or a wireless communication device externally connected to the vehicle computer. Or, the terminal may be a roadside device, such as a street lamp, a signal lamp or other roadside devices with a wireless communication function.

In an embodiment of the present disclosure, the terminal may support the uplink switching of the multiple bands.

Further, in an embodiment of the present disclosure, a first link may be, for example, one of the plurality of links on which the uplink switching of the multiple bands does not occur. A link in the embodiments of the present disclosure may be, for example, a radio frequency link.

Moreover, in an embodiment of the present disclosure, the at least one link other than the first link may be one link other than the first link, or a plurality of links other than the first link, or all links other than the first link.

In an embodiment of the present disclosure, reporting the transmission capability information to the network device includes:
reporting the transmission capability information to the network device, in which the transmission capability information indicates the capability of transmitting the data using the first link when uplink switching of two bands occurs on a second link, in which the second link is other than the first link in two links.

Further, in an embodiment of the present disclosure, the terminal may, for example, support uplink switching of two bands.

For example, in an embodiment of the present disclosure, the multiple bands may include, for example, two bands, and the two bands may refer to two different bands.

Further, in an embodiment of the present disclosure, the second link may be, for example, a link that the uplink switching of the multiple bands occurs on, and the first link may be, for example, a link that the uplink switching of the multiple bands does not occur in.

In an embodiment of the present disclosure, reporting the transmission capability information to the network device includes:
in response to switching between single-band and inter-band CA on the two links, reporting the transmission capability information to the network device.

In an embodiment of the present disclosure, reporting the transmission capability information to the network device includes:
reporting the transmission capability information to the network device via a signaling.

In an embodiment of the present disclosure, the transmission capability information includes at least one indicator bit, each indicator bit corresponds to a band, and an indication code carried in the indicator bit indicates whether a band corresponding to the indicator bit supports the capability of transmitting the data using a corresponding band of the first link when the uplink switching of the multiple bands occurs on the at least one link.

Further, in an embodiment of the present disclosure, for example, based in the indicator bit in the transmission capability information, it is possible to determine which band of the first link may be used to transmit data.

In an embodiment of the present disclosure, the indication code carried in the indicator bit indicating whether the band corresponding to the indicator bit supports the capability of transmitting the data using the corresponding band of the first link when the uplink switching of the multiple bands occurs on the at least one link, includes at least one of:
when the indication code carried in the indicator bit is a first value, the indication code carried in the indicator bit indicating that the band corresponding to the indicator bit supports the capability of transmitting the data using the corresponding band of the first link when the uplink switching of the multiple bands occurs on the at least one link; or
when the indication code carried in the indicator bit is a second value, the indication code carried in the indicator bit indicating that the band corresponding to the indicator bit does not support the capability of transmitting the data using the corresponding band of the first link when the uplink switching of the multiple bands occurs on the at least one link.

For example, in an embodiment of the present disclosure, the indication code carried in the indicator bit indicating whether the band corresponding to the indicator bit supports the capability of transmitting the data using the corresponding band of the first link when the uplink switching of the multiple bands occurs on the at least one link, for example, may include: when the indication code carried in the indicator bit is the first value, the indication code carried in the indicator bit indicating that the band corresponding to the indicator bit supports the capability of transmitting the data using the corresponding band of the first link when the uplink switching of the multiple bands occurs on the at least one link.

For example, in an embodiment of the present disclosure, the indication code carried in the indicator bit indicating whether the band corresponding to the indicator bit supports the capability of transmitting the data using the corresponding band of the first link when the uplink switching of the multiple bands occurs on the at least one link, for example, may include: when the indication code carried in the indicator bit is the second value, the indication code carried in the indicator bit indicating that the band corresponding to the indicator bit does not support the capability of transmitting the data using the corresponding band of the first link when the uplink switching of the multiple bands occurs on the at least one link.

For example, in an embodiment of the present disclosure, the indication code carried in the indicator bit indicating whether the band corresponding to the indicator bit supports the capability of transmitting the data using the corresponding band of the first link when the uplink switching of the multiple bands occurs on the at least one link, for example, may further include: when the indication code carried in the indicator bit is the first value, the indication code carried in the indicator bit indicating that the band corresponding to the indicator bit supports the capability of transmitting the data using the corresponding band of the first link when the uplink switching of the multiple bands occurs on the at least one link; and when the indication code carried in the indicator bit is the second value, the indication code carried in the indicator bit indicating that the band corresponding to the indicator bit does not support the capability of transmitting the data using the corresponding band of the first link when the uplink switching of the multiple bands occurs on the at least one link.

It should be noted that the above embodiments are not exhaustive but merely illustrative of some embodiments. The above embodiments may be implemented independently or in combination with others. The above embodiments are for illustration only and shall not be construed as a specific limitation to the protection scope of the embodiments of the present disclosure.

In summary, in the embodiments of the present disclosure, the transmission capability information is reported to the network device, in which the transmission capability information indicates the capability of transmitting the data using the first link when the uplink switching of the multiple bands occurs on the at least one link, in which the at least one link is other than the first link among the plurality of links. In the embodiments of the present disclosure, a reporting mechanism of the transmission capability information may be provided, so that data transmission of links does not interfere with each other when the uplink switching of the multiple bands occurs, thereby enhancing the data transmission efficiency. The present disclosure provides a processing method for a case of “capability information reporting” to ensure that the data transmission of the links does not interfere with each other when the uplink switching of the multiple bands occurs, thereby improving the system throughput and the data transmission efficiency.

FIG. 3 is a flowchart of a method for reporting capability information according to an embodiment of the present disclosure. The method is performed by a terminal. As shown in FIG. 3, the method may include S301.

At S301, transmission capability information is reported to a network device, in which the transmission capability information indicates a capability of transmitting the data using a first link when uplink switching of two bands occurs on a second link, in which the second link is other than the first link in two links.

In an embodiment of the present disclosure, a description of S301 may refer to a description of the above embodiments, which is not limited in the embodiments of the present disclosure. Optional examples in the embodiments of the present disclosure may be combined arbitrarily. When there is no conflict, the embodiments of the present disclosure may be combined with steps of other embodiments or optional examples of other embodiments.

In an embodiment of the present disclosure, the terminal, for example, may support uplink switching of multiple bands. Specifically, the terminal may support the uplink switching between the two bands. The two bands may be two bands determined from the multiple bands according to preset setting, or two bands actually used in the multiple bands.

Further, in an embodiment of the present disclosure, the multiple bands may include the two bands. The two bands may refer to two different bands. In response to supporting the uplink switching of the two bands, the transmission capability information is reported to the network device, in which the transmission capability information indicates the capability of transmitting the data using the first link when the uplink switching of the two bands occurs on the second link, in which the second link is other than the first link in the two links.

In an embodiment of the present disclosure, the uplink switching may include two cases. The first one may be, for example, switching between single-bands, that is, both links are switched, for example, A+A<->B+B, in which A and B are different bands. The second one may be, for example, switching between single-band and inter-band CA, that is, only one link is switched, while the other link remains unchanged, for example, A+A<->A+B, or for example, it may also be A+B<->B+B.

Further, in an embodiment of the present disclosure, the second link may be, for example, a link that the uplink switching of the multiple bands occurs on, and the first link may be, for example, a link that the uplink switching of the multiple bands does not occur in.

Further, in an embodiment of the present disclosure, multiple bands may include the two bands. The second link may be, for example, a link that the uplink switching of the two bands occurs on, and the first link may be, for example, a link that the uplink switching of the two bands does not occur in.

In addition, in an embodiment of the present disclosure, the transmission capability information indicates the capability of transmitting the data. The transmission capability information in the embodiments of the present disclosure indicates the capability of transmitting the data using the first link when the uplink switching of the two bands occurs on the second link in the two links.

In an embodiment of the present disclosure, a terminal capability for the uplink switching of the two bands is optional. A reporting granularity of the terminal capability is per band per band pair.

In an embodiment of the present disclosure, reporting the transmission capability information to the network device includes:
in response to switching between single-band and inter-band CA on the two links, reporting the transmission capability information to the network device.

For example, in an embodiment of the present disclosure, the terminal may report the transmission capability information to the network device when supporting uplink switching between the single-band and the inter-band CA.

Further, in an embodiment of the present disclosure, when the terminal supports switching between single-bands, the terminal may report the transmission capability information to the network device.

Further, in an embodiment of the present disclosure, when the terminal supports the switching between the single-bands, the terminal may not report the transmission capability information to the network device.

Further, in an embodiment of the present disclosure, the network device may be, for example, a base station.

In an embodiment of the present disclosure, reporting the transmission capability information to the network device includes:
reporting the transmission capability information to the network device via a signaling.

In an embodiment of the present disclosure, the transmission capability information includes two indicator bits, each indicator bit corresponds to a band, and an indication code carried in an indicator bit indicates whether a band corresponding to the indicator bit supports the capability of transmitting the data using a corresponding band of the first link when switching between a first band and a second band occurs on the second link in the two links.

For example, in an embodiment of the present disclosure, the indication code carried in the indicator bit indicating whether the band corresponding to the indicator bit supports the capability of transmitting the data using the corresponding band of the first link when the switching between the first band and the second band occurs on the second link in the two links, includes at least one of:
when the indication code carried in the indicator bit is a first value, the indication code carried in the indicator bit indicating that the band corresponding to the indicator bit supports the capability of transmitting the data using the corresponding band of the first link when the switching between the first band and the second band occurs on the second link in the two links; or
when the indication code carried in the indicator bit is a second value, the indication code carried in the indicator bit indicating that the band corresponding to the indicator bit does not support the capability of transmitting the data using the corresponding band of the first link when the switching between the first band and the second band occurs on the second link in the two links.

Further, in an embodiment of the present disclosure, the indication code carried in the indicator bit indicating whether the band corresponding to the indicator bit supports the capability of transmitting the data using the corresponding band of the first link when the switching between the first band and the second band occurs on the second link in the two links, for example, may include: when the indication code carried in the indicator bit is the first value, the indication code carried in the indicator bit indicating that the band corresponding to the indicator bit supports the capability of transmitting the data using the corresponding band of the first link when the switching between the first band and the second band occurs on the second link in the two links.

Further, in an embodiment of the present disclosure, the indication code carried in the indicator bit indicating whether the band corresponding to the indicator bit supports the capability of transmitting the data using the corresponding band of the first link when the switching between the first band and the second band occurs on the second link in the two links, for example, may include: when the indication code carried in the indicator bit is the second value, the indication code carried in the indicator bit indicating that the band corresponding to the indicator bit does not support the capability of transmitting the data using the corresponding band of the first link when the switching between the first band and the second band occurs on the second link in the two links.

Further, in an embodiment of the present disclosure, the indication code carried in the indicator bit indicating whether the band corresponding to the indicator bit supports the capability of transmitting the data using the corresponding band of the first link when the switching between the first band and the second band occurs on the second link in the two links, for example, may include: when the indication code carried in the indicator bit is the first value, the indication code carried in the indicator bit indicating that the band corresponding to the indicator bit supports the capability of transmitting the data using the corresponding band of the first link when the switching between the first band and the second band occurs on the second link in the two links; and when the indication code carried in the indicator bit is the second value, the indication code carried in the indicator bit indicating that the band corresponding to the indicator bit does not support the capability of transmitting the data using the corresponding band of the first link when the switching between the first band and the second band occurs on the second link in the two links.

For example, in an embodiment of the present disclosure, the first value only indicates that the band corresponding to the indicator bit supports the capability of transmitting the data using a corresponding band of the other link when the switching between the first band and the second band occurs on one of the two links, in which the first value does not specifically refer to a certain fixed number. The first value and the second value are different values. For example, when the first value is 1, the second value may be 0.

Further, in an embodiment of the present disclosure, the first band and the second band indicate different bands. The first band and the second band do not specifically refer to a certain band. For example, when a band range corresponding to the first band changes, the first band may also change accordingly.

In an embodiment of the present disclosure, the band corresponding to the indication bit includes the first band or the second band.

For example, in an embodiment of the present disclosure, the band corresponding to the indication bit may be, for example, the first band. In the case that the indication code carried in the indicator bit is the first value, it indicates that the band corresponding to the indicator bit supports the capability of transmitting the data using the first band of the first link when the switching between the first band and the second band occurs on the second link in the two links; and
in the case that the indication code carried in the indicator bit is the second value, it indicates that the band corresponding to the indicator bit does not support the capability of transmitting the data using the first band of the first link when the switching between the first band and the second band occurs on the second link in the two links.

For example, in an embodiment of the present disclosure, the band corresponding to the indication bit may be, for example, the second band. In the case that the indication code carried in the indicator bit is the first value, it indicates that the band corresponding to the indicator bit supports the capability of transmitting the data using the second band of the first link when the switching between the first band and the second band occurs on the second link in the two links; and
when the indication code carried in the indicator bit is the second value, the indication code carried in the indicator bit indicating that the band corresponding to the indicator bit does not support the capability of transmitting the data using the second band of the first link when the switching between the first band and the second band occurs on the second link in the two links.

For example, in an embodiment of the present disclosure, a format of the signaling may be as follows:

Bitmap=(0, 0). When a certain bit in the bitmap is 1, it indicates that a band in a band pair may transmit the data normally.

Further, in an embodiment of the present disclosure, assuming that the two bands are arranged in a specific order, for example, sorted by band number in an ascending order as band #0 and band #1, the transmission capability information may be indicated by a corresponding indicator bit in the Bitmap as follows:
0th bit in the Bitmap being 1 indicates: supporting that band #0 in band #0<->band #0 may transmit the data normally;
0th bit in the Bitmap being 0 indicates: not supporting that band #0 in band #0<->band #0 transmit the data normally;
1st bit in the Bitmap being 1 indicates: supporting that band #1 in band #1<->band #1 may transmit the data normally; and
1st bit in the Bitmap being 0 indicates: not supporting that band #1 in band #1<->band #1 transmit data normally.

In summary, in the embodiments of the present disclosure, the transmission capability information is reported to the network device, in which the transmission capability information indicates the capability of transmitting the data using the first link when the uplink switching of the two bands occurs on the second link, in which the second link is other than the first link in the two links. In the embodiments of the present disclosure, a reporting mechanism of the transmission capability information may be provided, so that data transmission of links does not interfere with each other when the uplink switching of the two bands occurs, thereby enhancing the data transmission efficiency. The present disclosure provides a processing method for a case of “capability information reporting” to ensure that the data transmission of the links does not interfere with each other when the uplink switching of the two bands occurs, thereby improving the system throughput and the data transmission efficiency.

FIG. 4 is a flowchart of a method for reporting capability information according to an embodiment of the present disclosure. The method is performed by a terminal. As shown in FIG. 4, the method may include S401.

At S401, in response to switching between single-band and inter-band CA on two links, the transmission capability information is reported to the network device.

In an embodiment of the present disclosure, a description of S401 may refer to a description of the above embodiments, which is not limited in the embodiments of the present disclosure. Optional examples in the embodiments of the present disclosure may be combined arbitrarily. When there is no conflict, the embodiments of the present disclosure may be combined with steps of other embodiments or optional examples of other embodiments.

For example, in an embodiment of the present disclosure, the terminal may report the transmission capability information to the network device when supporting uplink switching between the single-band and the inter-band CA.

In an embodiment of the present disclosure, the transmission capability information indicates the capability of transmitting the data. The transmission capability information in the embodiments of the present disclosure indicates the capability of transmitting the data using the first link when the uplink switching of two bands occurs on the second link, in which the second link is other than the first link in the two links.

In summary, in the embodiments of the present disclosure, in response to the switching between the single-band and the inter-band CA of the two links, the transmission capability information is reported to the network device. In the embodiments of the present disclosure, a reporting mechanism of the transmission capability information may be provided, so that data transmission of links does not interfere with each other when the uplink switching of the two bands occurs, thereby enhancing the data transmission efficiency. The embodiments of the present disclosure specifically disclose a solution in which the terminal reports the transmission capability information when the switching between the single-band and the inter-band CA of the two links occurs. The present disclosure provides a processing method for a case of “capability information reporting” to ensure that the data transmission of the links does not interfere with each other when the uplink switching of the two bands occurs, thereby improving the system throughput and the data transmission efficiency.

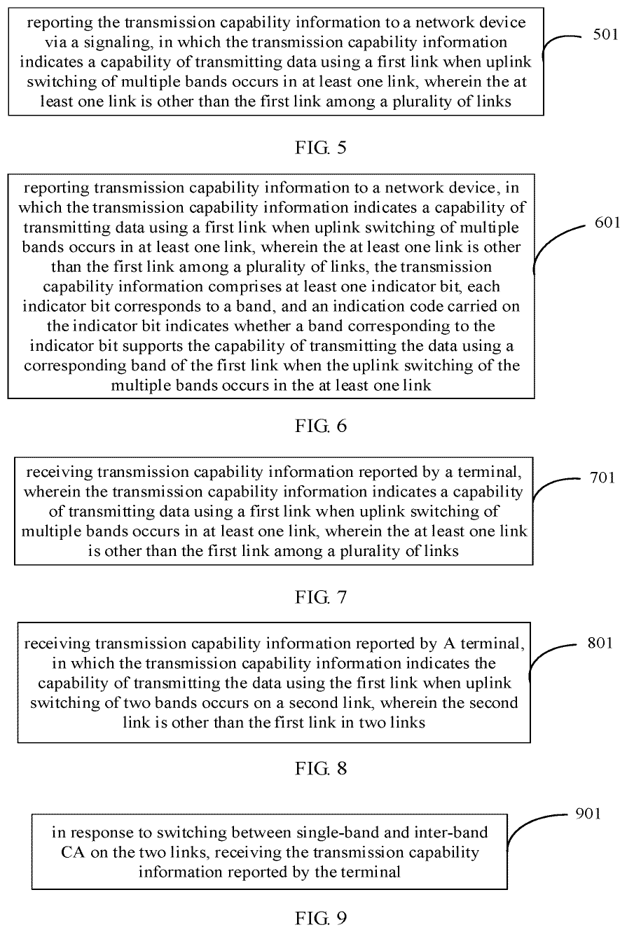

FIG. 5 is a flowchart of a method for reporting capability information according to an embodiment of the present disclosure. The method is performed by a terminal. As shown in FIG. 5, the method may include S501.

At S501, transmission capability information is reported to the network device via a signaling, in which the transmission capability information indicates a capability of transmitting data using a first link when uplink switching of multiple bands occurs on at least one link, in which the at least one link is other than the first link among a plurality of links.

In an embodiment of the present disclosure, a description of S501 may refer to a description of the above embodiments, which is not limited in the embodiments of the present disclosure. The optional examples in the embodiments of the present disclosure may be combined arbitrarily. When there is no conflict, the embodiments of the present disclosure may be combined with steps of other embodiments or optional examples of other embodiments.

For example, in an embodiment of the present disclosure, when the multiple bands here refer to, for example, two bands, a format of the signaling may be as follows:

Bitmap=(0, 0). When a certain bit in the bitmap is 1, it indicates that a band in a band pair may transmit the data normally.

In summary, in the embodiments of the present disclosure, the transmission capability information is reported to the network device via the signaling, in which the transmission capability information indicates the capability of transmitting the data using the first link when the uplink switching of the multiple bands occurs on the at least one link, in which the at least one link is other than the first link among the plurality of links. In the embodiments of the present disclosure, a reporting mechanism of the transmission capability information may be provided, so that data transmission of links does not interfere with each other when the uplink switching of the multiple bands occurs, thereby enhancing the data transmission efficiency. The embodiments of the present disclosure specifically disclose a solution for reporting the transmission capability information via the signaling. The present disclosure provides a processing method for a case of “capability information reporting” to ensure that the data transmission of the links does not interfere with each other when the uplink switching of the multiple bands occurs, thereby improving the system throughput and the data transmission efficiency.

FIG. 6 is a flowchart of a capability information reporting method according to yet an embodiment of the present disclosure. The method is performed by a terminal. As shown in FIG. 6, the method may include S601.

At S601, transmission capability information is reported to a network device, in which the transmission capability information indicates a capability of transmitting data using a first link when uplink switching of multiple bands occurs on at least one link, in which the at least one link is other than the first link among a plurality of links, the transmission capability information includes at least one indicator bit, each indicator bit corresponds to a band, and an indication code carried in the indicator bit indicates whether a band corresponding to the indicator bit supports the capability of transmitting the data using a corresponding band of the first link when the uplink switching of the multiple bands occurs on the at least one link.

In an embodiment of the present disclosure, a description of S601 may refer to a description of the above embodiments, which is not limited in the embodiments of the present disclosure. The optional examples in the embodiments of the present disclosure may be combined arbitrarily. When there is no conflict, the embodiments of the present disclosure may be combined with steps of other embodiments or optional examples of other embodiments.

In an embodiment of the present disclosure, the indication code carried in the indicator bit indicating whether the band corresponding to the indicator bit supports the capability of transmitting the data using the corresponding band of the first link when the uplink switching of the multiple bands occurs on the at least one link includes, at least one of:
when the indication code carried in the indicator bit is a first value, the indication code carried in the indicator bit indicating that the band corresponding to the indicator bit supports the capability of transmitting the data using the corresponding band of the first link when the uplink switching of the multiple bands occurs on the at least one link; or
when the indication code carried in the indicator bit is a second value, the indication code carried in the indicator bit indicating that the band corresponding to the indicator bit does not support the capability of transmitting the data using the corresponding band of the first link when the uplink switching of the multiple bands occurs on the at least one link.

For example, in an embodiment of the present disclosure, the indication code carried in the indicator bit indicating whether the band corresponding to the indicator bit supports the capability of transmitting the data using the corresponding band of the first link when the uplink switching of the multiple bands occurs on the at least one link, for example, may include: when the indication code carried in the indicator bit is the first value, the indication code carried in the indicator bit indicating that the band corresponding to the indicator bit supports the capability of transmitting the data using the corresponding band of the first link when the uplink switching of the multiple bands occurs on the at least one link.

For example, in an embodiment of the present disclosure, the indication code carried in the indicator bit indicating whether the band corresponding to the indicator bit supports the capability of transmitting the data using the corresponding band of the first link when the uplink switching of the multiple bands occurs on the at least one link, for example, may include: when the indication code carried in the indicator bit is the second value, the indication code carried in the indicator bit indicating that the band corresponding to the indicator bit does not support the capability of transmitting the data using the corresponding band of the first link when the uplink switching of the multiple bands occurs on the at least one link.

For example, in an embodiment of the present disclosure, the indication code carried in the indicator bit indicating whether the band corresponding to the indicator bit supports the capability of transmitting the data using the corresponding band of the first link when the uplink switching of the multiple bands occurs on the at least one link, for example, may include: in response to the indication code carried in the indicator bit being the first value, indicating that the band corresponding to the indicator bit supports the capability of transmitting the data using the corresponding band of the first link when the uplink switching of the multiple bands occurs on the at least one link; and when the indication code carried in the indicator bit is the second value, the indication code carried in the indicator bit indicating that the band corresponding to the indicator bit does not support the capability of transmitting the data using the corresponding band of the first link when the uplink switching of the multiple bands occurs on the at least one link.

In summary, in the embodiments of the present disclosure, the transmission capability information is reported to the network device. In the embodiments of the present disclosure, a reporting mechanism of the transmission capability information may be provided, so that data transmission of links does not interfere with each other during the uplink switching of the multiple bands, thereby enhancing the data transmission efficiency. The embodiments of the present disclosure disclose a solution for specific information of the transmission capability information. The present disclosure provides a processing method for a case of “capability information reporting” to ensure that the data transmission of the links does not interfere with each other during the uplink switching of the multiple bands, thereby improving the system throughput and the data transmission efficiency.

FIG. 7 is a flowchart of a method for reporting capability information according to an embodiment of the present disclosure. The method is performed by a network device. As shown in FIG. 7, the method may include S701.

At S701, transmission capability information reported by a terminal is received, in which the transmission capability information indicates a capability of transmitting data using a first link when uplink switching of multiple bands occurs on at least one link, in which the at least one link is other than the first link among a plurality of links.

In an embodiment of the present disclosure, the terminal may support the uplink switching of the multiple bands.

In an embodiment of the present disclosure, receiving the transmission capability information reported by the terminal includes:
receiving the transmission capability information reported by the terminal, in which the transmission capability information indicates the capability of transmitting the data using the first link when uplink switching of two bands occurs on a second link, in which the second link is other than the first link in two links.

In an embodiment of the present disclosure, receiving the transmission capability information reported by the terminal includes:
in response to switching between single-band and inter-band CA on the two links, receiving the transmission capability information reported by the terminal.

In an embodiment of the present disclosure, receiving the transmission capability information reported by the terminal includes:
receiving the transmission capability information reported by the terminal via a signaling.

In an embodiment of the present disclosure, the transmission capability information includes at least one indicator bit, each indicator bit corresponds to a band, and an indication code carried in the indicator bit indicates whether a band corresponding to the indicator bit supports the capability of transmitting the data using a corresponding band of the first link when the uplink switching of the multiple bands occurs on the at least one link.

In an embodiment of the present disclosure, the indication code carried in the indicator bit indicating whether the band corresponding to the indicator bit supports the capability of transmitting the data using the corresponding band of the first link when the uplink switching of the multiple bands occurs on the at least one link includes at least one of:
when the indication code carried in the indicator bit is a first value, the indication code carried in the indicator bit indicating that the band corresponding to the indicator bit supports the capability of transmitting the data using the corresponding band of the first link when the uplink switching of the multiple bands occurs on the at least one link; or
when the indication code carried in the indicator bit is a second value, the indication code carried in the indicator bit indicating that the band corresponding to the indicator bit does not support the capability of transmitting the data using the corresponding band of the first link when the uplink switching of the multiple bands occurs on the at least one link.

For example, in an embodiment of the present disclosure, the indication code carried in the indicator bit indicating whether the band corresponding to the indicator bit supports the capability of transmitting the data using the corresponding band of the first link when the uplink switching of the multiple bands occurs on the at least one link, for example, may include: when the indication code carried in the indicator bit is the first value, the indication code carried in the indicator bit indicating that the band corresponding to the indicator bit supports the capability of transmitting the data using the corresponding band of the first link when the uplink switching of the multiple bands occurs on the at least one link.

For example, in an embodiment of the present disclosure, the indication code carried in the indicator bit indicating whether the band corresponding to the indicator bit supports the capability of transmitting the data using the corresponding band of the first link when the uplink switching of the multiple bands occurs on the at least one link, for example, may include: when the indication code carried in the indicator bit is the second value, the indication code carried in the indicator bit indicating that the band corresponding to the indicator bit does not support the capability of transmitting the data using the corresponding band of the first link when the uplink switching of the multiple bands occurs on the at least one link.

For example, in an embodiment of the present disclosure, the indication code carried in the indicator bit indicating whether the band corresponding to the indicator bit supports the capability of transmitting the data using the corresponding band of the first link when the uplink switching of the multiple bands occurs on the at least one link, for example, may include: when the indication code carried in the indicator bit is the first value, the indication code carried in the indicator bit indicating that the band corresponding to the indicator bit supports the capability of transmitting the data using the corresponding band of the first link when the uplink switching of the multiple bands occurs on the at least one link; and when the indication code carried in the indicator bit is the second value, the indication code carried in the indicator bit indicating that the band corresponding to the indicator bit does not support the capability of transmitting the data using the corresponding band of the first link when the uplink switching of the multiple bands occurs on the at least one link.

In summary, in the embodiments of the present disclosure, the transmission capability information reported by the terminal is received, in which the transmission capability information indicates the capability of transmitting the data using the first link when the uplink switching of the multiple bands occurs on the at least one link, in which the at least one link is other than the first link among the plurality of links. In the embodiments of the present disclosure, a receiving mechanism of the transmission capability information may be provided, so that data transmission of links does not interfere with each other during the uplink switching of the multiple bands, thereby enhancing the data transmission efficiency. The present disclosure provides a processing method for a case of “capability information reporting” to ensure that the data transmission of the links does not interfere with each other during the uplink switching of the multiple bands, thereby improving the system throughput and the data transmission efficiency.

FIG. 8 is a flowchart of a method for reporting capability information according to an embodiment of the present disclosure. The method is performed by a network device. As shown in FIG. 8, the method may include S801.

At S801, transmission capability information reported by a terminal is received, in which the transmission capability information indicates a capability of transmitting data using a first link when uplink switching of two bands occurs on a second link, in which the second link is other than the first link in two links.

In an embodiment of the present disclosure, a description of S801 may refer to a description of the above embodiments, which is not limited in the embodiments of the present disclosure. The optional examples in the embodiments of the present disclosure may be combined arbitrarily. When there is no conflict, the embodiments of the present disclosure may be combined with steps of other embodiments or optional examples of other embodiments.

Further, in an embodiment of the present disclosure, receiving the transmission capability information reported by the terminal includes:
in response to switching between single-band and inter-band CA on the two links, receiving the transmission capability information reported by the terminal.

For example, in an embodiment of the present disclosure, receiving the transmission capability information reported by the terminal includes:
receiving the transmission capability information reported by the terminal via a signaling.

In an embodiment of the present disclosure, the transmission capability information includes at least one indicator bit, each indicator bit corresponds to a band, and an indication code carried in the indicator bit indicates whether a band corresponding to the indicator bit supports the capability of transmitting the data using a corresponding band of the first link when the uplink switching between a first band and a second band occurs on a second link in the two links.

For example, in an embodiment of the present disclosure, the indication code carried in the indicator bit indicating whether the band corresponding to the indicator bit supports the capability of transmitting the data using the corresponding band of the first link when the switching between the first band and the second band occurs on the second link in the two links includes at least one of:
when the indication code carried in the indicator bit is a first value, the indication code carried in the indicator bit indicating that the band corresponding to the indicator bit supports the capability of transmitting the data using the corresponding band of the first link when the switching between the first band and the second band occurs on the second link in the two links; or
when the indication code carried in the indicator bit is a second value, the indication code carried in the indicator bit indicating that the band corresponding to the indicator bit does not support the capability of transmitting the data using the corresponding band of the first link when the switching between the first band and the second band occurs on the second link in the two links.

Further, in an embodiment of the present disclosure, the indication code carried in the indicator bit indicating whether the band corresponding to the indicator bit supports the capability of transmitting the data using the corresponding band of the first link when the switching between the first band and the second band occurs on the second link in the two links, for example, may include: when the indication code carried in the indicator bit is the first value, the indication code carried in the indicator bit indicating that the band corresponding to the indicator bit supports the capability of transmitting the data using the corresponding band of the first link when the switching between the first band and the second band occurs on the second link in the two links.

Further, in an embodiment of the present disclosure, the indication code carried in the indicator bit indicating whether the band corresponding to the indicator bit supports the capability of transmitting the data using the corresponding band of the first link when the switching between the first band and the second band occurs on the second link in the two links, for example, may include: when the indication code carried in the indicator bit is the second value, the indication code carried in the indicator bit indicating that the band corresponding to the indicator bit does not support the capability of transmitting the data using the corresponding band of the first link when the switching between the first band and the second band occurs on the second link in the two links.

Further, in an embodiment of the present disclosure, the indication code carried in the indicator bit indicating whether the band corresponding to the indicator bit supports the capability of transmitting the data using the corresponding band of the first link when the switching between the first band and the second band occurs on the second link in the two links, for example, may include: when the indication code carried in the indicator bit is the first value, the indication code carried in the indicator bit indicating that the band corresponding to the indicator bit supports the capability of transmitting the data using the corresponding band of the first link when the switching between the first band and the second band occurs on the second link in the two links; and when the indication code carried in the indicator bit is the second value, the indication code carried in the indicator bit indicating that the band corresponding to the indicator bit does not support the capability of transmitting the data using the corresponding band of the first link when the switching between the first band and the second band occurs on the second link in the two links.

In summary, in the embodiments of the present disclosure, the transmission capability information reported by the terminal is received, in which the transmission capability information indicates the capability of transmitting the data using the first link when the uplink switching of the two bands occurs on the second link, in which the second link is other than the first link in the two links. In the embodiments of the present disclosure, a receiving mechanism of the transmission capability information may be provided, so that data transmission of links does not interfere with each other during the uplink switching of the two bands, thereby enhancing the data transmission efficiency. The present disclosure provides a processing method for a case of “capability information reporting” to ensure that the data transmission of the links does not interfere with each other during the uplink switching of the multiple bands, thereby improving the system throughput and the data transmission efficiency.

FIG. 9 is a flowchart of a method for reporting capability information according to an embodiment of the present disclosure. The method is performed by a network device. As shown in FIG. 9, the method may include S901.

At S901, in response to switching between single-band and inter-band CA on the two links, the transmission capability information reported by the terminal is received.

In an embodiment of the present disclosure, a description of S901 may refer to a description of the above embodiments, which is not limited in the embodiments of the present disclosure. The optional examples in the embodiments of the present disclosure may be combined arbitrarily. When there is no conflict, the embodiments of the present disclosure may be combined with steps of other embodiments or optional examples of other embodiments.

In summary, in the embodiments of the present disclosure, in response to switching between the single-band and the inter-band CA on the two links, the transmission capability information reported by the terminal is received. In the embodiments of the present disclosure, a receiving mechanism of the transmission capability information may be provided, so that data transmission of links does not interfere with each other during the uplink switching of the two bands, thereby enhancing the data transmission efficiency. The embodiments of the present disclosure specifically disclose a solution for receiving the transmission capability information when the switching between the single-band and the inter-band CA occurs on the two links. The present disclosure provides a processing method for a case of “capability information reporting” to ensure that the data transmission of the links does not interfere with each other during the uplink switching of the multiple bands, thereby improving the system throughput and the data transmission efficiency.

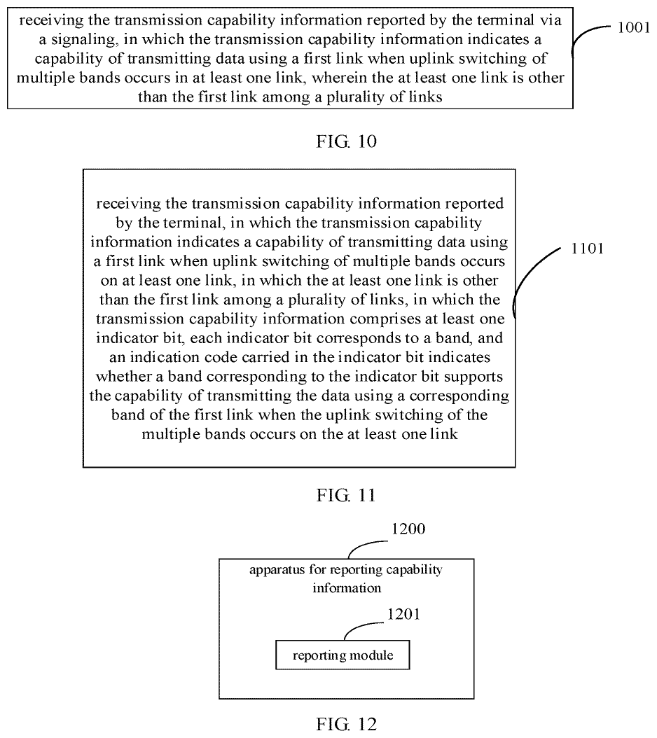

FIG. 10 is a flowchart of a method for reporting capability information according to an embodiment of the present disclosure. The method is performed by a network device. As shown in FIG. 10, the method may include S1001.

At S1001, transmission capability information reported by a terminal is received via a signaling, in which the transmission capability information indicates a capability of transmitting data using a first link when uplink switching of multiple bands occurs on at least one link, in which the at least one link is other than the first link among a plurality of links.

In an embodiment of the present disclosure, a description of S1001 may refer to a description of the above embodiments, which is not limited in the embodiments of the present disclosure. The optional examples in the embodiments of the present disclosure may be combined arbitrarily. When there is no conflict, the embodiments of the present disclosure may be combined with steps of other embodiments or optional examples of other embodiments.

In summary, in the embodiments of the present disclosure, the transmission capability information reported by the terminal is received via the signaling, in which the transmission capability information indicates the capability of transmitting the data using the first link when the uplink switching of the multiple bands occurs on the at least one link, in which the at least one link is other than the first link among the plurality of links. In the embodiments of the present disclosure, a receiving mechanism of the transmission capability information may be provided, so that data transmission of links does not interfere with each other during the uplink switching of the multiple bands, thereby enhancing the data transmission efficiency. The embodiments of the present disclosure specifically disclose a solution for receiving the transmission capability information via the signaling. The present disclosure provides a processing method for a case of “capability information reporting” to ensure that the data transmission of the links does not interfere with each other during the uplink switching of the multiple bands, thereby improving the system throughput and the data transmission efficiency.

FIG. 11 is a flowchart of a method for reporting capability information according to an embodiment of the present disclosure. The method is performed by a network device. As shown in FIG. 11, the method may include S1101.

At S1101, transmission capability information reported by a terminal is received, in which the transmission capability information indicates a capability of transmitting data using a first link when uplink switching of multiple bands occurs on at least one link, in which the at least one link is other than the first link among a plurality of links, in which the transmission capability information includes at least one indicator bit, each indicator bit corresponds to a band, and an indication code carried in the indicator bit indicates whether a band corresponding to the indicator bit supports the capability of transmitting the data using a corresponding band of the first link when the uplink switching of the multiple bands occurs on the at least one link.

In an embodiment of the present disclosure, a description of S1101 may refer to a description of the above embodiments, which is not limited in the embodiments of the present disclosure. The optional examples in the embodiments of the present disclosure may be combined arbitrarily. When there is no conflict, the embodiments of the present disclosure may be combined with steps of other embodiments or optional examples of other embodiments.

In an embodiment of the present disclosure, the indication code carried in the indicator bit indicating whether the band corresponding to the indicator bit supports the capability of transmitting the data using the corresponding band of the first link when the uplink switching of the multiple bands occurs on the at least one link includes at least one of:
when the indication code carried in the indicator bit is a first value, the indication code carried in the indicator bit indicating that the band corresponding to the indicator bit supports the capability of transmitting the data using the corresponding band of the first link when the uplink switching of the multiple bands occurs on the at least one link; or
when the indication code carried in the indicator bit is a second value, the indication code carried in the indicator bit indicating that the band corresponding to the indicator bit does not support the capability of transmitting the data using the corresponding band of the first link when the uplink switching of the multiple bands occurs on the at least one link.

In summary, in the embodiments of the present disclosure, the transmission capability information reported by the terminal is received, in which the transmission capability information indicates the capability of transmitting the data using the first link when the uplink switching of the multiple bands occurs on the at least one link, in which the at least one link is other than the first link among the plurality of links. In the embodiments of the present disclosure, a receiving mechanism of the transmission capability information may be provided, so that data transmission of links does not interfere with each other during the uplink switching of the multiple bands, thereby enhancing the data transmission efficiency. The embodiments of the present disclosure disclose a solution for specific information of the transmission capability information. The present disclosure provides a processing method for a case of “capability information reporting” to ensure that the data transmission of the links does not interfere with each other during the uplink switching of the multiple bands, thereby improving the system throughput and the data transmission efficiency.

For example, in an embodiment of the present disclosure, when a terminal supports the uplink switching of the two bands, the transmission capability information may be reported to a base station.

Optionally, in an embodiment of the present disclosure, in response to switching between single-band and inter-band CA on the two links, the terminal may report the transmission capability information to the base station.

Optionally, in an embodiment of the present disclosure, reported transmission capability information indicates which band in which band pair may transmit normally, unaffected by switching of the other link. The terminal may report, for example, the transmission capability information to the base station via a signaling.

Optionally, in an embodiment of the present disclosure, a format of the signaling may be as follows:

Bitmap=(0, 0). When a certain bit in the bitmap is 1, it indicates that a band in a band pair may transmit data normally.

Further, in an embodiment of the present disclosure, assuming that two bands are arranged in a specific order, for example, sorted by band number in an ascending order as band #0 and band #1, the transmission capability information may be indicated by a corresponding indicator bit in the Bitmap as follows:
0th bit in the Bitmap being 1 indicates: supporting that band #0 in band #0<->band #0 may transmit the data normally; and
1st bit in the bitmap being 1 indicates: supporting that band #1 in band #1<->band #1 may transmit the data normally.

In an embodiment of the present disclosure, the band numbers may be sorted, for example, in an ascending order.

FIG. 12 is a block diagram of an apparatus for reporting capability information according to an embodiment of the present disclosure. As shown in FIG. 12, the apparatus 1200 may be arranged on a terminal, and may include a reporting module 1201.

The reporting module 1201 is configured to report transmission capability information to a network device, in which the transmission capability information indicates a capability of transmitting data using a first link when uplink switching of multiple bands occurs on at least one link, in which the at least one link is other than the first link among a plurality of links.

In summary, in the apparatus for reporting capability information in the embodiments of the present disclosure, the reposting module reports the transmission capability information to the network device, in which the transmission capability information indicates the capability of transmitting the data using the first link when the uplink switching of the multiple bands occurs on the at least one link, in which the at least one link is other than the first link among the plurality of links. In the embodiments of the present disclosure, a reporting mechanism of the transmission capability information may be provided, so that data transmission of links does not interfere with each other during the uplink switching of the two bands, thereby enhancing the data transmission efficiency. The present disclosure provides a processing method for a case of “capability information reporting” to ensure that the data transmission of the links does not interfere with each other during the uplink switching of the two bands, thereby improving the system throughput and the data transmission efficiency.

Optionally, in an embodiment of the present disclosure, the reporting module 1201 is configured to report the transmission capability information to the network device, and is specifically configured to:
report the transmission capability information to the network device, in which the transmission capability information indicates the capability of transmitting the data using the first link when uplink switching of two bands occurs on a second link, in which the second link is other than the first link in two links.

Optionally, in an embodiment of the present disclosure, the reporting module 1201 is configured to report the transmission capability information to the network device, and is specifically configured to:
in response to switching between single-band and inter-band CA on the two links, report the transmission capability information to the network device.

Optionally, in an embodiment of the present disclosure, the reporting module 1201 is configured to report the transmission capability information to the network device, and is specifically configured to:
report the transmission capability information to the network device via a signaling.

Optionally, in an embodiment of the present disclosure, the transmission capability information includes at least one indicator bit, each indicator bit corresponds to a band, and an indication code carried in the indicator bit indicates whether a band corresponding to the indicator bit supports the capability of transmitting the data using a corresponding band of the first link when the uplink switching of the multiple bands occurs on the at least one link.

Optionally, in an embodiment of the present disclosure, the indication code carried in the indicator bit indicating whether the band corresponding to the indicator bit supports the capability of transmitting the data using the corresponding band of the first link when the uplink switching of the multiple bands occurs on the at least one link includes at least one of:
when the indication code carried in the indicator bit is a first value, the indication code carried in the indicator bit indicating that the band corresponding to the indicator bit supports the capability of transmitting the data using the corresponding band of the first link when the uplink switching of the multiple bands occurs on the at least one link; or
when the indication code carried in the indicator bit is a second value, the indication code carried in the indicator bit indicating that the band corresponding to the indicator bit does not support the capability of transmitting the data using the corresponding band of the first link when the uplink switching of the multiple bands occurs on the at least one link.

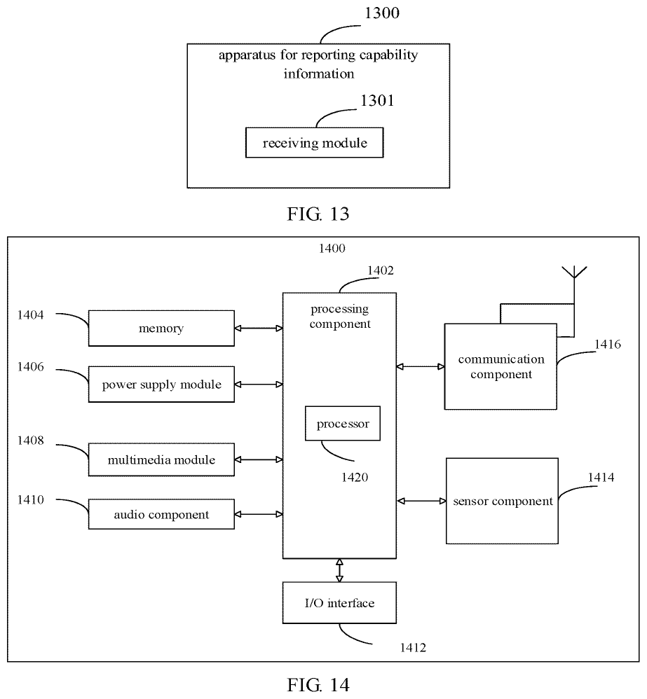

FIG. 13 is a block diagram of an apparatus for reporting capability information according to an embodiment of the present disclosure. As shown in FIG. 13, the apparatus 1300 may be arranged on a network device, and may include a receiving module 1301.

The receiving module 1301 is configured to receive transmission capability information reported by a terminal, in which the transmission capability information indicates a capability of transmitting data using a first link when uplink switching of multiple bands occurs on at least one link, in which the at least one link is other than the first link among a plurality of links.

In summary, in the apparatus for reporting capability information in the embodiments of the present disclosure, the receiving module receives the transmission capability information reported by the terminal, in which the transmission capability information indicates the capability of transmitting the data using the first link when the uplink switching of the multiple bands occurs on the at least one link, in which the at least one link is other than the first link among the plurality of links. In the embodiments of the present disclosure, a receiving mechanism of the transmission capability information may be provided, so that data transmission of links does not interfere with each other during the uplink switching of the two bands, thereby enhancing the data transmission efficiency. The present disclosure provides a processing apparatus for a case of “capability information reporting” to ensure that the data transmission of the links does not interfere with each other during the uplink switching of the two bands, thereby improving the system throughput and the data transmission efficiency.

Optionally, in an embodiment of the present disclosure, the receiving module 1301 is configured to receive the transmission capability information reported by the terminal, and is specifically configured to:
receive the transmission capability information reported by the terminal, in which the transmission capability information indicates the capability of transmitting the data using the first link when uplink switching of two bands occurs on a second link, in which the second link is other than the first link in two links.

Optionally, in an embodiment of the present disclosure, the receiving module 1301 is configured to receive the transmission capability information reported by the terminal, and is specifically configured to:
in response to switching between single-band and inter-band CA on the two links, receive the transmission capability information reported by the terminal.

Optionally, in an embodiment of the present disclosure, the receiving module 1301 is configured to receive the transmission capability information reported by the terminal, and is specifically configured to:
receive the transmission capability information reported by the terminal via a signaling.

Optionally, in an embodiment of the present disclosure, the transmission capability information includes at least one indicator bit, each indicator bit corresponds to a band, and an indication code carried in the indicator bit indicates whether a band corresponding to the indicator bit supports the capability of transmitting the data using a corresponding band of the first link when the uplink switching of the multiple bands occurs on the at least one link.

Optionally, in an embodiment of the present disclosure, the indication code carried in the indicator bit indicating whether the band corresponding to the indicator bit supports the capability of transmitting the data using the corresponding band of the first link when the uplink switching of the multiple bands occurs on the at least one link includes at least one of:
when the indication code carried in the indicator bit is a first value, the indication code carried in the indicator bit indicating that the band corresponding to the indicator bit supports the capability of transmitting the data using the corresponding band of the first link when the uplink switching of the multiple bands occurs on the at least one link; or
when the indication code carried in the indicator bit is a second value, the indication code carried in the indicator bit indicating that the band corresponding to the indicator bit does not support the capability of transmitting the data using the corresponding band of the first link when the uplink switching of the multiple bands occurs on the at least one link.

FIG. 14 is a block diagram of a terminal UE 1400 according to an embodiment of the present disclosure. For example, UE 1400 may be a mobile phone, a computer, a digital broadcast terminal, a messaging device, a game console, a tablet device, a medical device, an exercise device, a personal digital assistant, and so on.

Referring to FIG. 14, UE 1400 may include one or more of: a processing component 1402, a memory 1404, a power component 1406, a multimedia component 1408, an audio component 1410, an input/output (I/O) interface 1412, a sensor component 1414, and a communication component 1416.

The processing component 1402 normally controls the overall operation (such as operations associated with displaying, telephone calls, data communications, camera operations and recording operations) of UE 1400. The processing component 1402 may include at least one processor 1420 to execute instructions so as to perform all or part of the steps of the above method. In addition, the processing component 1402 may include at least one module to facilitate interactions between the processing component 1402 and other components. For example, the processing component 1402 may include a multimedia unit to facilitate interactions between the multimedia component 1408 and the processing component 1402.

The memory 1404 is configured to store various types of data to support operations at UE 1400. Examples of such data include instructions for any application or method operated on UE 1400, contact data, phone book data, messages, images, videos and the like. The memory 1404 may be realized by any type of volatile or non-volatile storage devices, or a combination thereof, such as a static random access memory (SRAM), an electrically erasable programmable read only memory (EEPROM), an erasable programmable read only memory (EPROM), a programmable read only memory (PROM), a read only memory (ROM), a magnetic memory, a flash memory, a disk or an optical disk.

The power component 1406 provides power to various components of UE 1400. The power component 1406 may include a power management system, at least one power source and other components associated with power generation, management, and distribution of UE 1400.

The multimedia component 1408 includes a screen that provides an output interface between UE 1400 and a user. In some embodiments, the screen may include a liquid crystal display (LCD) and a touch panel (TP). If the screen includes a touch panel, the screen may be implemented as a touch screen to receive input signals from the user. The touch panel includes at least one touch sensor to sense touches, slides, and gestures on the touch panel. The touch sensor may sense not only boundaries of the touches or sliding actions, but also durations and pressures related to the touches or sliding operations. In some embodiments, the multimedia component 1408 includes a front camera and/or a rear camera. When UE 1400 is in an operation mode such as a shooting mode or a video recording mode, the front camera and/or the rear camera may receive external multimedia data. Each of the front camera and the rear camera may be a fixed optical lens system or have a focal length and an optical zoom capability.

The audio component 1410 is configured to output and/or input an audio signal. For example, the audio component 1410 includes a microphone (MIC) that is configured to receive an external audio signal when UE 1400 is in an operation mode such as a call mode, a recording mode, and a voice recognition mode. The received audio signal may be further stored in the memory 1404 or transmitted via the communication component 1416. In some embodiments, the audio component 1410 also includes a speaker for outputting audio signals.

The I/O interface 1412 provides an interface between the processing component 1402 and a peripheral interface unit. The peripheral interface unit may be a keyboard, a click wheel, buttons and so on. These buttons may include, but are not limited to, a home button, a volume button, a start button, and a locking button.

The sensor assembly 1414 includes one or more sensors for providing UE 1400 with various aspects of states assessments. For example, the sensor component 1414 may detect an ON/OFF state of UE 1400 and a relative positioning of the components. For example, the components may be a display and a keypad of UE 1400. The sensor component 1414 may also detect a change in position of UE 1400 or a component of UE 1400, presence or absence of contact of the user with UE 1400, orientation or acceleration/deceleration of UE 1400 and a temperature change of UE 1400. The sensor component 1414 may include a proximity sensor configured to detect the presence of nearby objects without any physical contact. The sensor component 1414 may also include a light sensor (such as a CMOS or a CCD image sensor) for use in imaging applications. In some embodiments, the sensor component 1414 may also include an acceleration sensor, a gyroscope sensor, a magnetic sensor, a pressure sensor, or a temperature sensor.

The communication component 1416 is configured to facilitate wired or wireless communication between UE 1400 and other devices. UE 1400 may access a wireless network based on a communication standard such as WiFi, 2G, 3G, or a combination thereof. In an illustrative embodiment, the communication component 1416 receives broadcast signals or broadcast-associated information from an external broadcast management system via a broadcast channel. In an illustrative embodiment, the communication component 1416 also includes a near field communication (NFC) module to facilitate short range communication. For example, the NFC module may be implemented based on radio frequency identification (RFID) technology, infrared data association (IrDA) technology, ultra-wideband (UWB) technology, Bluetooth (BT) technology and other technologies.

In an illustrative embodiment, UE 1400 may be implemented by at least one application specific integrated circuit (ASIC), digital signal processor (DSP), digital signal processing device (DSPD), programmable logic devices (PLD), field programmable gate array (FPGA), controller, microcontroller, microprocessor, or other electronic component, so as to perform the above method.

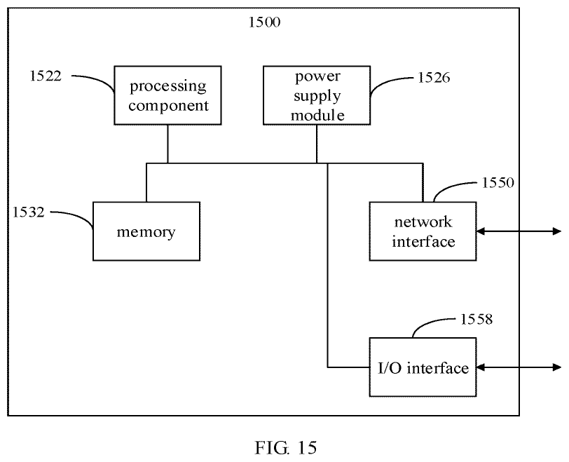

FIG. 15 is a block diagram of a network device 1500 according to an embodiment of the present disclosure. For example, the network device 1500 is provided as a network device. Referring to FIG. 15, the network device 1500 includes a processing component 1522 which further includes at least one processor and a memory resource represented by a memory 1532. The memory 1532 is configured to store instructions executable by the processing component 1522, such as an application program. The application program stored in the memory 1532 may include one or more modules, in which each corresponds to a set of instructions. In addition, the processing component 1522 is configured to execute instructions so as to implement the above method that is applied on the network device, for example, as shown in FIG. 7.

The network device 1500 may also include a power component 1526 configured to perform power management for the network device 1500, a wired or wireless network interface 1550 configured to connect the network device 1500 to a network, and an input/output (I/O) interface 1558. The network device 1500 may operate an operating system stored in the memory 1532, such as Windows Server™, Mac OS X™, Unix™, Linux™, FreeBSD™ or similar operating systems.

In the embodiments provided by the present disclosure, the method in the embodiments of the present disclosure is described from perspectives of the network device and the UE, respectively. To perform functions of the method provided in the above embodiments, the network device and the UE may include a hardware structure and a software module, and realize the above functions with the hardware structure, the software module, or a combination of the hardware structure and the software module. A specific function may be performed as the hardware structure, the software module, or the hardware structure plus the software module.

The embodiments of the present disclosure provide a communication device. The communication device may include a transceiver module and a processing module. The transceiver module may include a sending module and/or a receiving module. The sending module is configured to implement a sending function, and the receiving module is configured to implement a receiving function, and the transceiver module is configured to implement the sending function and/or the receiving function.

The communication device may be a terminal (such as the terminal in the above method embodiments), an apparatus in the terminal, or an apparatus capable of being used by matching with the terminal. Or, the communication device may be the network device, an apparatus in the network device, or an apparatus capable of being used by matching with the network device.

The embodiments of the present disclosure provide another communication device. The communication device may be a network device, or a terminal (such as the terminal in the above method embodiments), or a chip, a chip system, a processor, etc. that supports the network device to implement the method, or a chip, a chip system, a processor, etc. that supports the terminal to implement the method. The device is configured to implement the method in the above method embodiments. For details, refer to the description in the above method embodiments.

The communication device may include one or more processors. The processor may be a general-purpose processor or a dedicated processor. For example, it may be a baseband processor or a central processing unit. The baseband processor is configured to process communication protocols and communication data, and the central processor is configured to control communication devices (such as network devices, baseband chips, terminals, terminal chips, DU or CU, etc.) to execute computer programs and process computer program data.

Optionally, the communication device may also include one or more memories on which a computer program is stored. When the computer program is executed by the memory, the communication device implements the method in the above method embodiments. Optionally, the memory may also store data. The communication device and the memory may be set separately or integrated together.

Optionally, the communication device may also include a transceiver and an antenna. The transceiver may be called a transceiving unit, a transceiving machine, or a transceiving circuit, etc., to achieve a transceiving function. The transceiver may include a receiver and a transmitter. The receiver may be called a receiver or a receiving circuit, etc., to achieve a receiving function; and the transmitter may be called a transmitter or a transmitting circuit, etc., to achieve a transmitting function.

Optionally, the communication device includes one or more interface circuits. The interface circuit is configured to receive code instructions and transmit the code instructions to the processor. When the code instructions are running on the processor, the communication device is caused to implement the method in the above method embodiments.

When the communication device is a terminal (such as the terminal in the above method embodiments), the processor is configured to implement the method shown in any one of FIGS. 2 to 6.

When the communication device is a network device, the processor is configured to implement the method in any one of FIGS. 7 to 11.

In an implementation, the processor may include a transceiver configured to achieve the receiving and transmitting function. For example, the transceiver may be a transceiving circuit, or an interface, or an interface circuit. The transceiving circuit, the interface, or the interface circuit configured to achieve the receiving and transmitting function may be set separately or integrated together. The transceiving circuit, the interface or the interface circuit may be configured to read and write code/data, or the transceiving circuit, the interface or the interface circuit may be configured to transmit signals.

In an implementation, the processor may store a computer program. When the computer program is running on the processor, the communication device is caused to implement the method in the above method embodiments. The computer program may be solidified in the processor. In this way, the processor may be implemented in hardware.

In an implementation, the communication device may include a circuit that may achieve the transmitting or receiving or communicating function in the above method embodiments. The processor and transceiver in the present disclosure may be implemented in an integrated circuit (IC), an analog IC, a radio frequency integrated circuit (RFIC), a mixed-signal IC, an application specific integrated circuit (ASIC), a printed circuit board (PCB), an electronic device, etc. The processor and transceiver may also be manufactured with various IC process technologies, such as a complementary oxide semiconductor (CMOS), nMetal-oxide-semiconductor (NMOS), a positive channel metal oxide semiconductor (PMOS), a bipolar junction transistor (BJT), a bipolar CMOS (BiCMOS), silicon germanium (SiGe), gallium arsenide (GaAs), etc.

The communication device in the above embodiments may be a network device or a terminal (such as the terminal in the above method embodiments), but the scope of the communication device in the present disclosure is not limited to this, and the structure of the communication device may not be restricted. The communication device may be an independent device or part of a larger device. For example, the communication device may be:
(1) an independent IC, or a chip, or a chip system or a subsystem;
(2) a collection including one or more IC, optionally, the IC collection may also include storage components for storing data and computer programs;
(3) an ASIC, such as a modem;
(4) modules embedded in other devices;
(5) a receiver, a terminal, an intelligent terminal, a cellular phone, a wireless device, a handheld phone, a mobile unit, a vehicle-mounted device, a network device, a cloud device, an artificial intelligence device, etc.;
(6) others.

For the case where the communication device may be a chip or a chip system, the chip includes a processor and an interface. There may be one or more processors, and there may be one or more interfaces.

Optionally, the chip further includes a memory for storing necessary computer programs and data.

Those skilled in the art may also understand that the various illustrative logical blocks and steps listed in the embodiments of the present disclosure may be implemented by electronic hardware, computer software, or their combination. Whether such a function is implemented in hardware or software depends on a specific application and a design requirement of the overall system. Those skilled in the art may use, for each specific application, a variety of methods to achieve the above function, but such implementation shall not be regarded as going beyond the scope of the protection of the embodiments of the present disclosure.

The present disclosure also provides a readable storage medium for storing instructions. When the instructions are executed by a computer, functions of any one of the above method embodiments are performed.

The present disclosure also provides a computer program product. When the computer program product is executed by a computer, functions of any one of the above method embodiments are performed.

In the above embodiments, the functions may be wholly or partially implemented by software, hardware, firmware, or any combination of them. When implemented by software, the functions may be implemented in whole or in part in the form of a computer program product. The computer program product includes one or more computer programs. Procedures or functions according to embodiments of the present disclosure are wholly or partially generated when the computer program is loaded and executed on a computer. The computer may be a general-purpose computer, a dedicated computer, a computer network, or other programmable device. The computer program may be stored in a computer-readable storage medium or transmitted from one computer-readable storage medium to another. For example, the computer program may be transmitted from one website, computer, server, or data center to another website, computer, server, or data center via wire (such as a coaxial cable, a fiber optic, a digital subscriber line (DSL)) or wireless (such as infrared, wireless, microwave). The computer-readable storage medium may be any available medium that may be accessed by a computer, or a data storage device such as a server that integrates one or more of the available media, or a data center. The available medium media be a magnetic medium (such as a floppy disk, a hard disk and a magnetic tape), an optical medium (such as a digital video disk (DVD)), or a semiconductor medium (such as a solid state disk (SSD)).

Those skilled in the art may understand that various numbers such as first and second involved in the present disclosure are distinguished merely for convenience of description, and are not intended to limit the scope of the embodiments of the present disclosure, but also not to indicate an order of precedence.

The term “at least one” in the present disclosure may also be described as one or more, and the more may be two, three, four, or any greater quantity, which is not limited in the present disclosure. In the embodiment of the present disclosure, technical features are distinguished by terms “first”, “second”, “third”, “A”, “B”, “C” and “D”, etc., and the technical features described by the terms “first”, “second”, “third”, “A”, “B”, “C” and “D”, etc. are not in a sequential order or in an order of size.

Other embodiments of the present disclosure will be apparent to those skilled in the art from consideration of the specification and practice of the present disclosure disclosed here. This application is intended to cover any variations, uses, or adaptations of the present disclosure following general principles of the disclosure and including common knowledge or conventional technical means in the art that are not disclosed herein. It is intended that the specification and examples be considered as illustrative only, with a true scope and spirit of the present disclosure being indicated by the following claims.

It will be appreciated that the present disclosure is not limited to the exact construction that has been described above and illustrated in the accompanying drawings, and that various modifications and changes can be made without departing from the scope thereof. It is intended that the scope of the present disclosure only be limited by the appended claims.

1. A method for reporting capability information, performed by a terminal, comprising:
reporting transmission capability information to a network device, wherein the transmission capability information indicates a capability of transmitting data using a first link when uplink switching of multiple bands occurs on at least one link, wherein the at least one link is other than the first link among a plurality of links.

2. The method of claim 1, wherein reporting the transmission capability information to the network device comprises:
reporting the transmission capability information to the network device, wherein the transmission capability information indicates the capability of transmitting the data using the first link when uplink switching of two bands occurs on a second link, wherein the second link is other than the first link in two links.

3. The method of claim 2, wherein reporting the transmission capability information to the network device comprises:
in response to switching between single-band and inter-band carrier aggregation (CA) on the two links, reporting the transmission capability information to the network device.

4. The method of claim 1, wherein reporting the transmission capability information to the network device comprises:
reporting the transmission capability information to the network device via a signaling.

5. The method of claim 1, wherein the transmission capability information comprises at least one indicator bit, each indicator bit corresponds to a band, and an indication code carried in the indicator bit indicates whether a band corresponding to the indicator bit supports the capability of transmitting the data using a corresponding band of the first link when the uplink switching of the multiple bands occurs on the at least one link.

6. The method of claim 5, wherein the indication code carried in the indicator bit indicating whether the band corresponding to the indicator bit supports the capability of transmitting the data using the corresponding band of the first link when the uplink switching of the multiple bands occurs on the at least one link, comprises at least one of:
when the indication code carried in the indicator bit is a first value, the indication code carried in the indicator bit indicating that the band corresponding to the indicator bit supports the capability of transmitting the data using the corresponding band of the first link when the uplink switching of the multiple bands occurs on the at least one link; or
when the indication code carried in the indicator bit is a second value, the indication code carried in the indicator bit indicating that the band corresponding to the indicator bit does not support the capability of transmitting the data using the corresponding band of the first link when the uplink switching of the multiple bands occurs on the at least one link.

7. A capability information reporting method, performed by a network device, comprising:
receiving transmission capability information reported by a terminal, wherein the transmission capability information indicates a capability of transmitting data using a first link when uplink switching of multiple bands occurs on at least one link, wherein the at least one link is other than the first link among a plurality of links.

8. The method of claim 7, wherein receiving the transmission capability information reported by the terminal comprises:
receiving the transmission capability information reported by the terminal, wherein the transmission capability information indicates the capability of transmitting the data using the first link when uplink switching of two bands occurs on a second link, wherein the second link is other than the first link in two links.

9. The method of claim 8, wherein receiving the transmission capability information reported by the terminal comprises:
in response to switching between single-band and inter-band carrier aggregation (CA) on the two links, receiving the transmission capability information reported by the terminal.

10. The method of claim 7, wherein receiving the transmission capability information reported by the terminal comprises:
receiving the transmission capability information reported by the terminal via a signaling.

11. The method of claim 7, wherein the transmission capability information comprises at least one indicator bit, each indicator bit corresponds to a band, and an indication code carried in the indicator bit indicates whether a band corresponding to the indicator bit supports the capability of transmitting the data using a corresponding band of the first link when the uplink switching of the multiple bands occurs on the at least one link.

12. The method of claim 11, wherein the indication code carried in the indicator bit indicating whether the band corresponding to the indicator bit supports the capability of transmitting the data using the corresponding band of the first link when the uplink switching of the multiple bands occurs on the at least one link comprises at least one of:
when the indication code carried in the indicator bit is a first value, the indication code carried in the indicator bit indicating that the band corresponding to the indicator bit supports the capability of transmitting the data using the corresponding band of the first link when the uplink switching of the multiple bands occurs on the at least one link; or
when the indication code carried in the indicator bit is a second value, the indication code carried in the indicator bit indicating that the band corresponding to the indicator bit does not support the capability of transmitting the data using the corresponding band of the first link when the uplink switching of the multiple bands occurs on the at least one link.

13-14. (canceled)

15. A terminal, comprising:
a processor; and
a memory for storing a computer program, wherein when the computer program stored in the memory is executed by the processor, the terminal is caused to implement a method comprising:
reporting transmission capability information to a network device, wherein the transmission capability information indicates a capability of transmitting data using a first link when uplink switching of multiple bands occurs on at least one link, wherein the at least one link is other than the first link among a plurality of links.

16. A network device, comprising:
a processor; and
a memory for storing a computer program, wherein when the computer program stored in the memory is executed by the processor, the network device is caused to implement the method of claim 7.

17. (canceled)

18. A non-transitory computer-readable storage medium for storing instructions, wherein when the instructions are executed, the method of claim 1 is implemented.

19. The terminal of claim 15, wherein reporting the transmission capability information to the network device comprises:
reporting the transmission capability information to the network device, wherein the transmission capability information indicates the capability of transmitting the data using the first link when uplink switching of two bands occurs on a second link, wherein the second link is other than the first link in two links.

20. The terminal of claim 19, wherein reporting the transmission capability information to the network device comprises:
in response to switching between single-band and inter-band carrier aggregation (CA) on the two links, reporting the transmission capability information to the network device.

21. The terminal of claim 15, wherein reporting the transmission capability information to the network device comprises:
reporting the transmission capability information to the network device via a signaling.

22. The terminal of claim 15, wherein the transmission capability information comprises at least one indicator bit, each indicator bit corresponds to a band, and an indication code carried in the indicator bit indicates whether a band corresponding to the indicator bit supports the capability of transmitting the data using a corresponding band of the first link when the uplink switching of the multiple bands occurs on the at least one link.

23. The terminal of claim 22, wherein the indication code carried in the indicator bit indicating whether the band corresponding to the indicator bit supports the capability of transmitting the data using the corresponding band of the first link when the uplink switching of the multiple bands occurs on the at least one link, comprises at least one of:
when the indication code carried in the indicator bit is a first value, the indication code carried in the indicator bit indicating that the band corresponding to the indicator bit supports the capability of transmitting the data using the corresponding band of the first link when the uplink switching of the multiple bands occurs on the at least one link; or
when the indication code carried in the indicator bit is a second value, the indication code carried in the indicator bit indicating that the band corresponding to the indicator bit does not support the capability of transmitting the data using the corresponding band of the first link when the uplink switching of the multiple bands occurs on the at least one link.
